(19) United States
(12) Patent Application Publication
(10) Pub. No.: US 2010/0019750 A1
(43) Pub. Date: Jan. 28, 2010

(54) POWER CONVERTOR AND CURRENT DETECTION APPARATUS THEREOF

(75) Inventors: Yi-Chung Chou, Taipei City (TW); Chih-Yuan Kuo, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ITE TECH. INC., Hsinchu (TW)

(21) Appl. No.: 12/236,511

(22) Filed: Sep. 24, 2008

(30) Foreign Application Priority Data
Jul. 24, 2008 (TW) 97128120

(51) Int. Cl. G05F 1/10

(52) U.S. Cl. 323/284

(57) ABSTRACT

A current detection apparatus including a current detection circuit, a voltage regulation power supply circuit, and a package carrier is disclosed. The current detection circuit has a reference terminal and a detection terminal. The voltage regulation power supply circuit is used to generate an output voltage and includes a current transmission terminal for transmitting a current. The package carrier is used to carry the current detection circuit, the voltage regulation power supply circuit, a reference pad, and a current transmission pad. The package carrier includes at least one common voltage lead. The current transmission pad is coupled to the reference pad through at least one bonding wire such that an equivalent resistance is formed on the coupling path between the current transmission pad and the reference pad.

### CROSS-REFERENCE TO RELATED APPLICATION

This application claims the priority benefit of Taiwan application serial no. 97128120, filed on Jul. 24, 2008. The entirety of the above-mentioned patent application is hereby incorporated by reference herein and made a part of specification.

### BACKGROUND OF THE INVENTION

1. Field of the Invention

The present invention generally relates to a power converter, and more particularly, to a current detection apparatus of a power converter.

2. Description of Related Art

Following the rapid popularization of electronic products, the development of integrated circuit (IC) chips, a heart of the electronic product, is trending toward multifunction. Therefore, the capability of providing multiple operation voltages by one single chip has become very important in the modern IC development. Accordingly, a power converter was developed and has been widely used.

The power converter is a type of switching voltage regulator. FIG. 1 illustrates a conventional power converter. The basic principle of the power converter 100 is that switching operation of a power transistor (not shown) of a power regulation power supply circuit 120 is controlled by an internal voltage regulation control circuit 110 to generate a current I to thereby generate an output voltage VOUT. However, the value of the current I generated by the voltage regulation power supply circuit 120 is generally very high, which can often result in the noise problem.

To overcome the above problem, the conventional power converter usually performs a current limiting operation when the current is unduly high. FIG. 2 illustrates another conventional power converter. Referring to FIG. 2, the power converter 200 further includes a current detection circuit 230, and a resistor R1 is series-connected on the path along which the current I flows to the ground voltage GND. As such, the current detection circuit 230 can obtain the value of the current I by merely measuring the voltage across the resistor R1, and employ a voltage regulation control circuit 210 to limit the current I generated by the voltage regulation power supply circuit 220. However, the resistor R1 is disposed outside a package carrier 250 of a power converter chip 240, thus increasing the fabrication cost due to the increased circuit area.

FIG. 3 illustrates another conventional power converter. Referring to FIG. 3, the resistor R1 is embedded in the power converter chip 340 of the power converter 300 to overcome the problem of increasing the circuit area. However, since the resistance value of the resistor R1 can hardly be controlled to a high level of precision during the chip fabrication. Accordingly, the current I detected by the current detection circuit 330 is not precise, thereby degrading the performance of the power converter 300.

### SUMMARY OF THE INVENTION

Accordingly, the present invention provides a current detection apparatus which employs the resistance formed by bonding wires between the reference terminal and the detection terminal to detect the current.

The present invention also provides a power converter which employs the resistance formed by bonding wires between the reference terminal and the detection terminal in the power converter chip to detect the current.

The present invention provides a current detection apparatus which includes a current detection circuit, a voltage regulation power supply circuit, and a package carrier. The current detection circuit has a reference terminal and a detection terminal. The reference terminal is electrically connected to a reference pad. The reference pad is electrically connected to a common voltage pad. The voltage regulation power supply circuit is used to generate an output voltage and includes a current transmission terminal for transmitting a current. The current transmission terminal is electrically connected to a current transmission pad and the detection terminal. The package carrier is used to carry the current detection circuit, the voltage regulation power supply circuit, the reference pad, and the current transmission pad. The package carrier includes at least one common voltage lead for electrically connection with the common voltage pad.

It is to be noted that the current transmission pad is coupled to the reference pad through at least one bonding wire such that an equivalent resistance is formed on the coupling path between the current transmission pad and the reference pad.

The present invention also provides another current detection apparatus which includes a current detection circuit, a voltage regulation power supply circuit, and a package carrier. The current detection circuit has a reference terminal and a detection terminal. The reference terminal is electrically connected to a reference pad. The reference pad is electrically connected to a common voltage pad. The voltage regulation power supply circuit is used to generate an output voltage and includes a current transmission terminal for transmitting a current. The current transmission terminal is electrically connected to a current transmission pad. The package carrier is used to carry the current detection circuit, the voltage regulation power supply circuit, the reference pad, and the current transmission pad. The package carrier includes at least one common voltage lead for electrically connection with the common voltage pad.

It is to be noted that the current transmission pad is coupled to the reference pad through at least one bonding wire such that an equivalent resistance is formed on the coupling path between the current transmission pad and the reference pad.

The present invention further provides a power converter which includes a power converter chip and a package carrier. The power converter chip is used to generate an output voltage and includes a current detection circuit and a voltage regulation power supply circuit. The current detection circuit has a reference terminal and a detection terminal. The reference terminal is electrically connected to a reference pad. The reference pad is electrically connected to a common voltage pad. The voltage regulation power supply circuit is configured to generate the output voltage and includes a current transmission terminal for transmitting a current. The current transmission terminal is electrically connected to a current transmission pad and the detection terminal. The package carrier is used to carry the power converter chip. The package carrier includes at least one common voltage lead for electrically connection with the common voltage pad.

In addition, the current transmission pad is coupled to the reference pad through at least one bonding wire such that an equivalent resistance is formed on the coupling path between the current transmission pad and the reference pad.

The present invention further provides another power converter which includes a power converter chip and a package carrier. The power converter chip is used to generate an output voltage and includes a current detection circuit and a voltage regulation power supply circuit. The current detection circuit has a reference terminal and a detection terminal. The reference terminal is electrically connected to a reference pad. The reference pad is electrically connected to a common voltage pad. The voltage regulation power supply circuit is used to generate the output voltage and includes a current transmission terminal for transmitting a current. The current transmission terminal is electrically connected to a current transmission pad. The package carrier is used to carry the power converter chip. The package carrier includes at least one common voltage lead for electrically connection with the common voltage pad.

It is to be noted that the current transmission pad is coupled to the reference pad through at least one bonding wire such that an equivalent resistance is formed on the coupling path between the current transmission pad and the reference pad.

The present invention employs the bonding wires to form an equivalent resistance and enables the current transmitted by the voltage regulation power supply circuit to flow through the bonding wires. The current detection circuit detects the value of the current transmitted by the voltage regulation power supply circuit by detecting the voltage drop due to the equivalent resistance. The equivalent resistance formed by the bonding wires does not occupy the circuit area and is not affected by the error of the chip fabrication, thus effectively reducing the fabrication cost and improve the precision of the current detection.

In order to make the aforementioned and other features and advantages of the present invention more comprehensible, embodiments accompanied with figures are described in detail below.

### BRIEF DESCRIPTION OF THE DRAWINGS

FIGS. 1 through 3 illustrate conventional power converter.

FIGS. 4A through 4D illustrate different implementations of a current detection apparatus according to a first embodiment of the present invention.

FIGS. 5A through 5G illustrate different implementations of a current detection apparatus according to a second embodiment of the present invention.

FIG. 6 illustrates a current detection apparatus according to a third embodiment of the present invention.

FIG. 7 illustrates a current detection apparatus according to a fourth embodiment of the present invention.

FIG. 8 illustrates a power converter according to one embodiment of the present invention.

FIG. 9 illustrates a power converter according to another embodiment of the present invention.

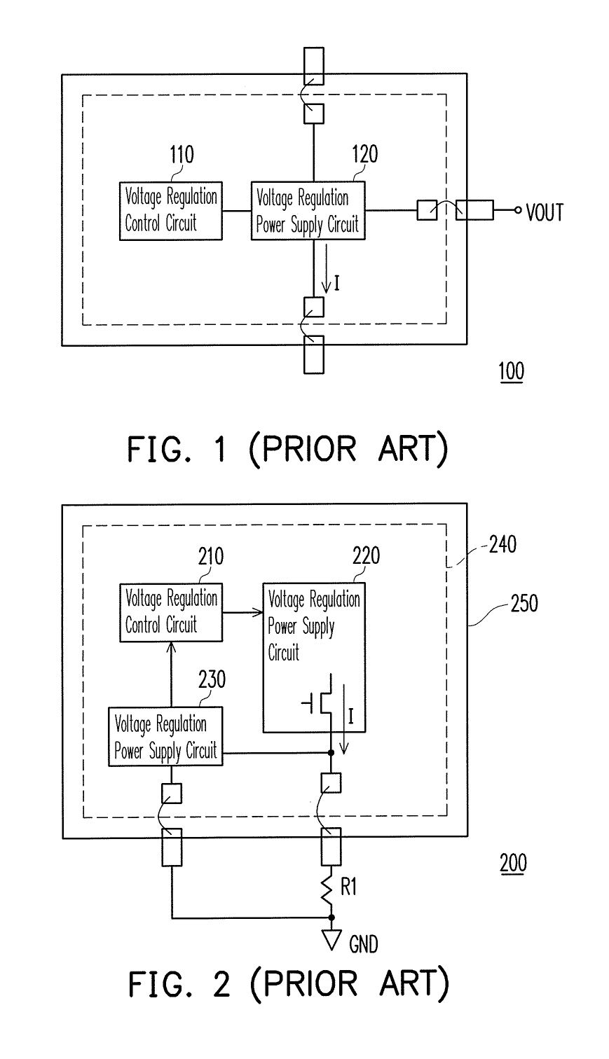

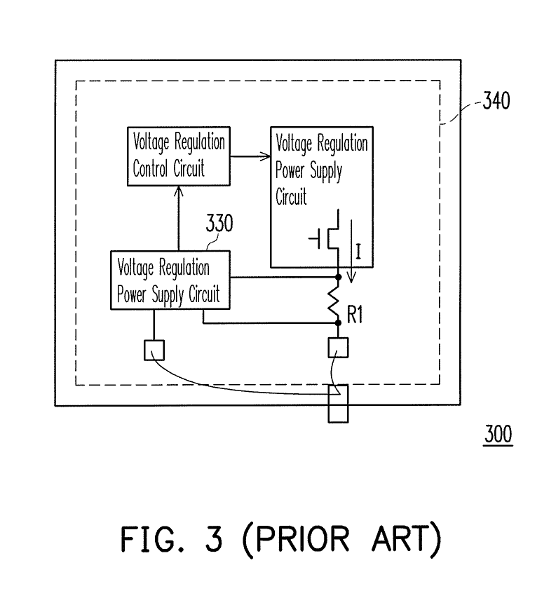

### DESCRIPTION OF THE EMBODIMENTS

Reference will now be made in detail to the embodiments of the present invention, examples of which are illustrated in the accompanying drawings. The embodiments are described below in order to explain the present invention by referring to the figures.

### First Embodiment

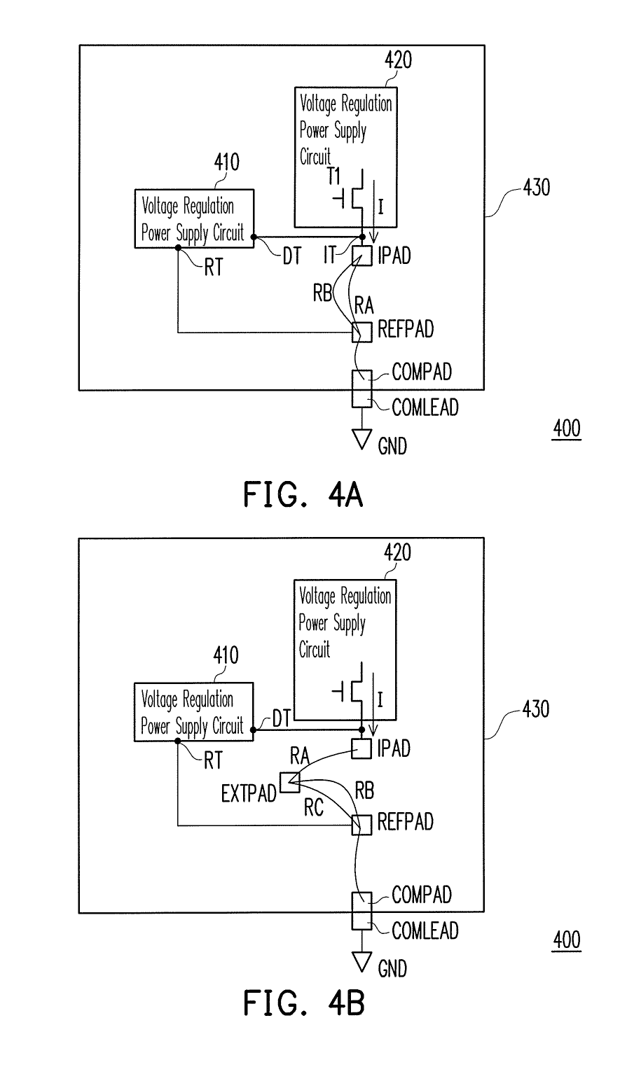

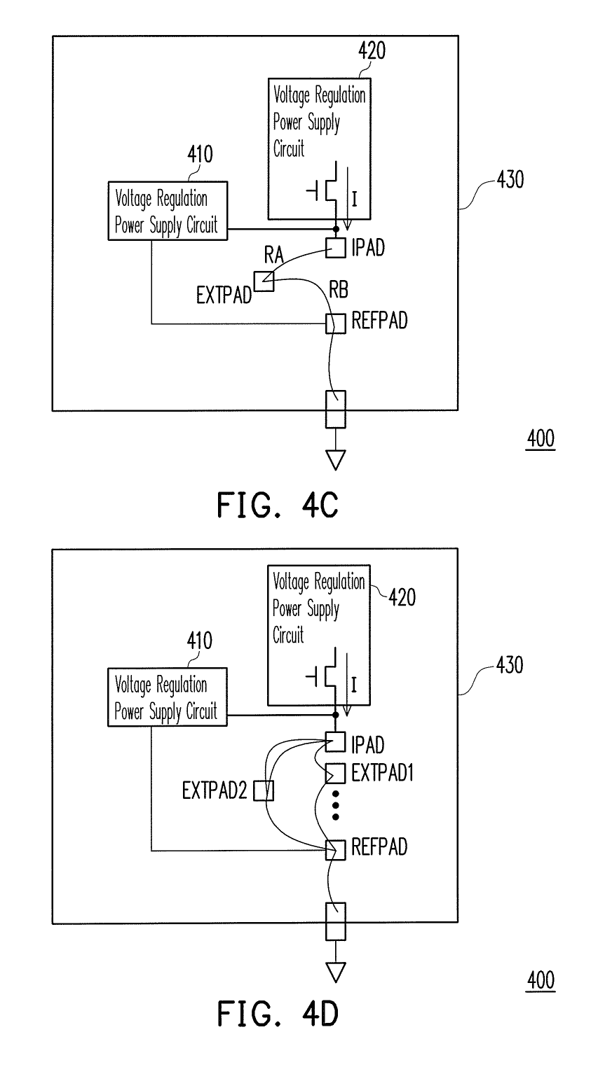

FIG. 4A illustrates a current detection apparatus according to a first embodiment of the present invention. Referring to FIG. 4A, the current detection apparatus 400 includes a current detection circuit 410 and a voltage regulation power supply circuit 420. The voltage regulation power supply circuit 420 includes a power transistor T1. The power transistor T1 generates a current I in response to a signal received at the gate of the power transistor T1. The first source/drain or the second source/drain is electrically connected to a current transmission terminal IT. In the first embodiment of the present invention, the current detection apparatus 400 includes a reference pad REFPAD, a common voltage pad COMPAD, and a current transmission pad IPAD. The reference pad REFPAD is electrically connected to a reference terminal RT of the current detection circuit 410. The current transmission pad IPAD is electrically connected to the current transmission terminal IT of the voltage regulation power supply circuit 420 that is used to transmit the current I. The current transmission terminal IT is electrically connected to the detection terminal DT of the current detection circuit 410. The above described current detection circuit 410, voltage regulation power supply circuit 420, reference pad REFPAD and current transmission pad IPAD are all carried in a package carrier 430.

The package carrier 430 includes at least one common voltage lead COMLEAD electrically connected to one common voltage pad COMPAD. Since the common voltage in the present embodiment is the ground voltage GND, the common volt age lead COMLEAD is electrically connected to the ground voltage GND. To enable the current I to flow through a resistor to the ground voltage GND, in the first embodiment, the current transmission pad IPAD and the reference pad REFPAD are connected through two bonding wires RA and RB, and the reference pad REFPAD and the common voltage pad COMPAD are connected through one bonding wire.

It is to be noted that the function of the bonding wires RA and RB is to form an equivalent resistance on a transmission path of the current I. Because the bonding wires RA and RB are connected in parallel, the value R of the equivalent resistance is RA×RB/(RA+RB). In addition, the bonding wire connected between the reference pad REFPAD and the common voltage pad COMPAD is only used to electrically connect the reference pad REFPAD to the current transmission pad IPAD via the package carrier 430 such that the current detection apparatus 400 can normally operate. To obtain the current I, the current detection circuit 410 needs only detect the voltage between the reference pad REFPAD and the current transmission pad IPAD (i.e., the voltage between the reference terminal RT and detection terminal DT) V, which satisfies V=R×I. Therefore, it is unnecessary to calculate the resistance of the bonding wire between the reference pad REFPAD and the common voltage pad COMPAD.

It should be understood the number of the bonding wires between the current transmission pad IPAD and the reference pad REFPAD is not intended to be limited to two. Rather, only one or more than two bonding wires can be used to provide the equivalent resistance to enable the current detection circuit 410 to detect the current I.

FIG. 4B illustrates another implementation of the current detection apparatus according to the first embodiment of the present invention. Referring to FIG. 4B, in this implementation, the current detection apparatus further includes an extra pad EXTPAD in addition to the current transmission pad IPAD, reference pad REFPAD and common voltage pad COMPAD. The addition of the extra pad EXTPAD provides various different manners of forming the equivalent resistance between the current transmission pad IPAD and reference pad REFPAD. In the present implementation, a bonding wire RA is connected between the current transmission pad IPAD and the extra pad EXTPAD, and two parallel bonding wires RB and RC are connected between the extra pad EXTPAD and common voltage pad COMPAD. As such, the equivalent resistance R is equal to RA+RB×RC/(RB+RC).

FIG. 4C is another implementation of the current detection apparatus according to the first embodiment of the present invention. Referring to FIG. 4C, the difference between the present implementation and the previous implementation is that only one bonding wire RB is connected between the extra pad EXTPAD and the common voltage pad COMPAD. As such, the equivalent resistance R is equal to RA+RB. From the two different implementations illustrated in FIG. 4B and FIG. 4C, it can be seen that there is no limitation regarding the number of the bonding wires connected between the pads but rather the number of the bonding wires can be varied according to design requirements.

FIG. 4D illustrates a further implementation of the current detection apparatus according to the first embodiment of the present invention. The present implementation includes multiple extra pads EXTPAD 1˜EXTPAD 2, and multiple bonding wires connected among the extra pads EXTPAD 1˜EXTPAD 2, reference pad REFPAD and current transmission pad IPAD such that an equivalent resistance is formed between the reference pad REFPAD and the current transmission pad IPAD to enable the current detection circuit 410 to detect the current I.

It should be noted that, in each of the various implementations of the current detection apparatus 400 of the first embodiment, the package carrier 430 can be encapsulated by sealing resin to protect the bonding wires and prevent the equivalent resistance from varying with outer environment.

### Second Embodiment

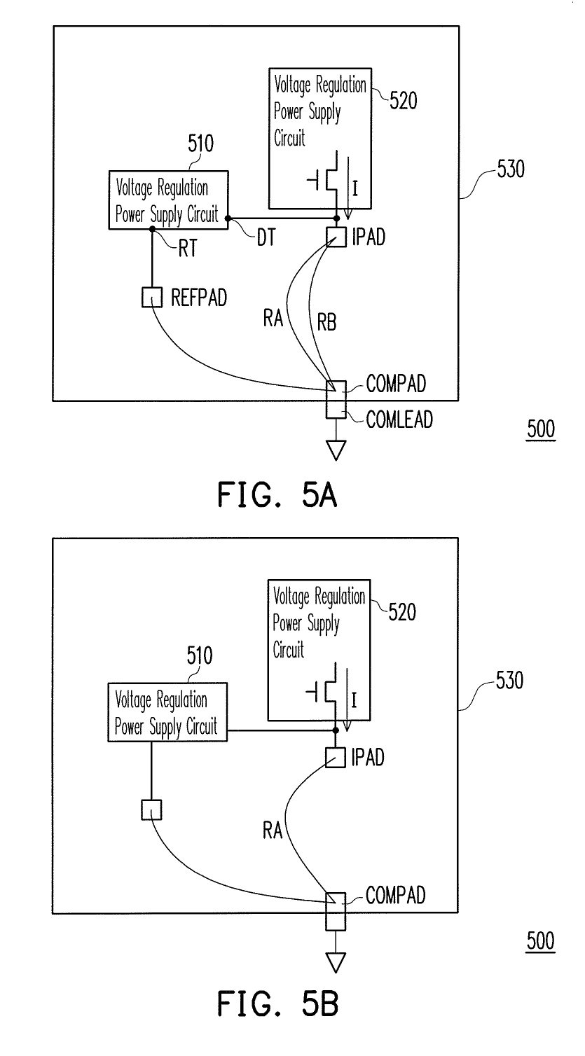

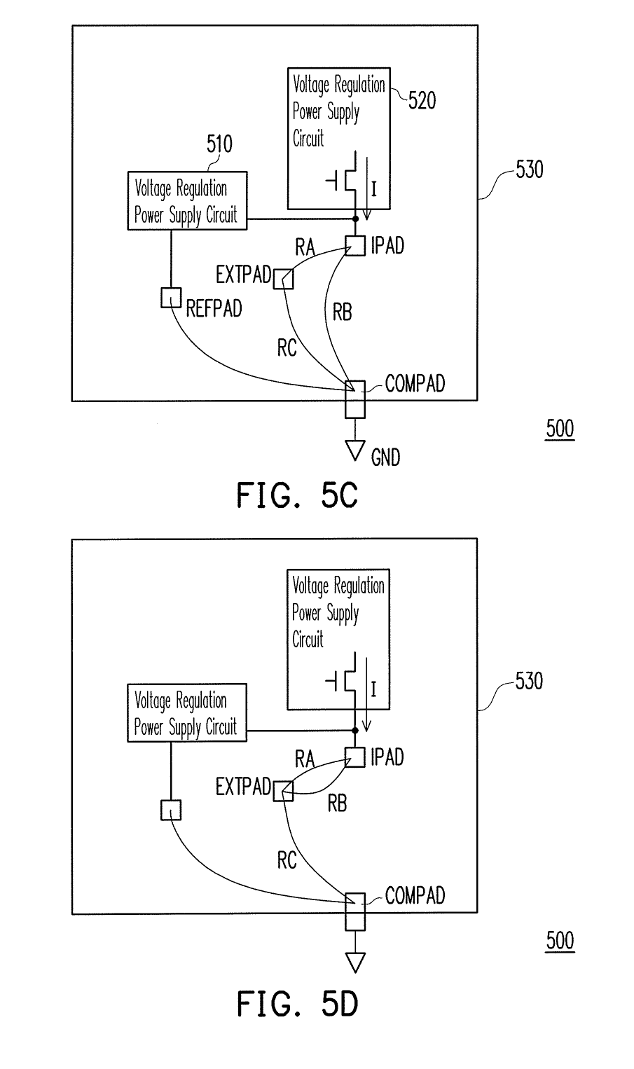

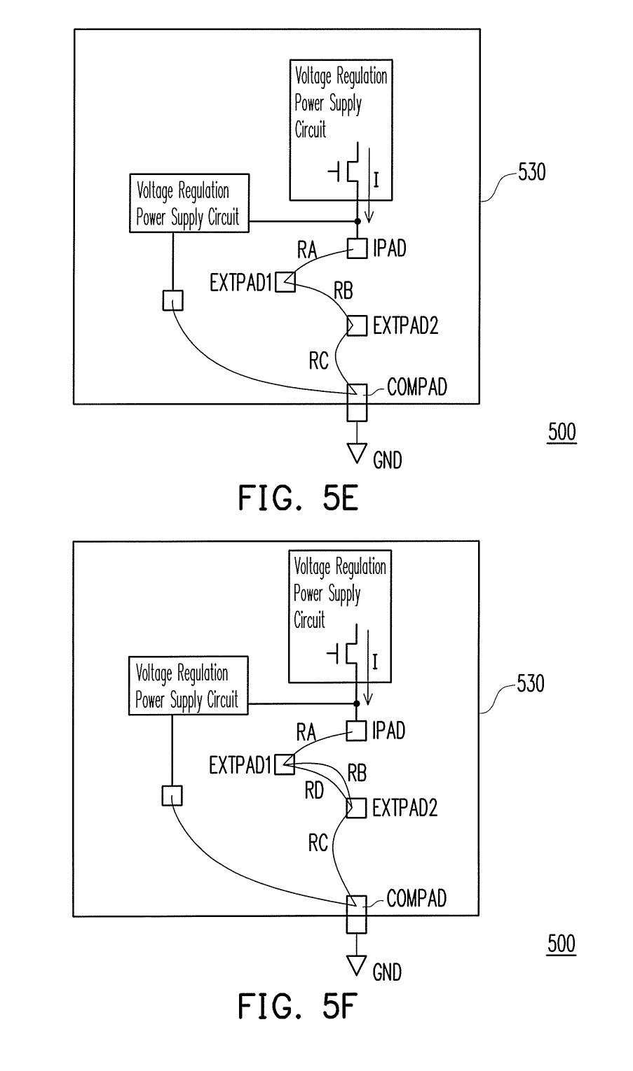

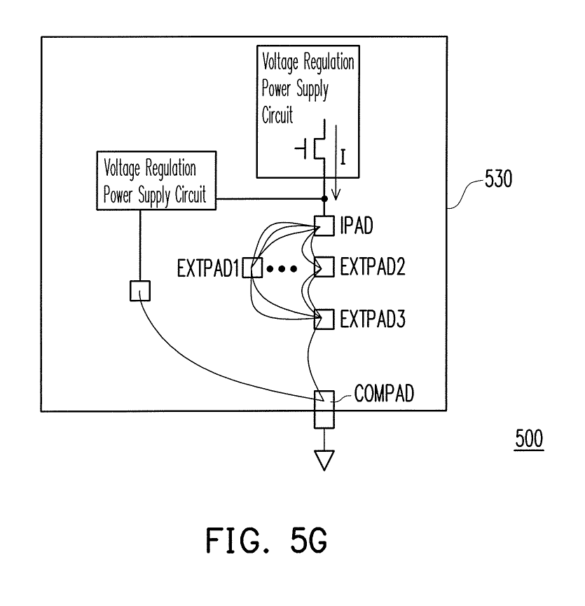

FIG. 5A illustrates a current detection apparatus according to a second embodiment of the present invention. Referring to FIG. 5A, in the second embodiment, the current detection apparatus 500 includes a current detection circuit 510 and a voltage regulation power supply circuit 520. The voltage regulation power supply circuit 520 includes a power transistor T1 for switching and generating a current I. Similar to the first embodiment, the current detection apparatus 500 includes a reference pad REFPAD, a common voltage pad COMPAD, and a current transmission pad IPAD. The reference pad REFPAD is electrically connected to a reference terminal RT of the current detection circuit 510. The current transmission pad IPAD is electrically connected to the current transmission terminal IT of the voltage regulation power supply circuit 420 that is used to transmit the current I. The current transmission terminal IT is electrically connected to the detection terminal DT of the current detection circuit 510. The above described current detection circuit 510, voltage regulation power supply circuit 520, reference pad REFPAD and current transmission pad IPAD are all carried in a package carrier 530.

The difference between the second embodiment and the first embodiment is that, in the second embodiment, the reference pad REFPAD is electrically connected to the common voltage pad COMPAD via bonding wires, but not electrically connected to the current transmission pad IPAD via bonding wires. As such, the current detection circuit 510 must employ the voltage between the current transmission pad IPAD and the common voltage pad COMPAD (i.e., the voltage between the reference terminal RT and the detection terminal DT) to detect the current I.

As shown in FIG. 5A, two bonding wires RA and RB are used to electrically connect the current transmission pad IPAD and the common voltage pad COMPAD. Because the bonding wires RA and RB are connected in parallel, the equivalent resistance R between the current transmission pad IPAD and the common voltage pad COMPAD is R=RA×RB/(RA+RB), and the voltage detected by the current detection circuit 510 is V=I×R.

Similar to the first embodiment, the number of the bonding wire between the current transmission pad IPAD and the common voltage pad COMPAD shown in FIG. 5A is not intended to be limited to two. Rather, only one bonding wire RA (equivalent resistance R=RA) can be used in another implementation of the second embodiment as illustrated in FIG. 5B. In other implementations, more than two bonding wires can be used.

FIG. 5C is another implementation of the current detection apparatus according to the second embodiment of the present invention. Referring to FIG. 5C, this implementation of the current detection apparatus further includes an extra pad EXTPAD. A bonding wire RA is connected between the current transmission pad IPAD and the extra pad EXTPAD, a bonding wire RC is connected between the EXTPAD and the common voltage pad COMPAD, and a bonding wire RB is connected between the current transmission pad IPAD and the common voltage pad COMPAD. As such, the equivalent resistance R between the current transmission pad IPAD and the common voltage pad COMPAD is R=(RA+RC)×RB/(RA+RB+RC).

In addition, the number of the extra pads EXTPAD of the above described implementations could be more than one, and the arrangement of the bonding wires between the pads is not intended to be limited to the arrangement illustrated in FIG. 5C. FIG. 5D, FIG. 5E, and FIG. 5F illustrates various implementations of the current detection apparatus according to the second embodiment of the present invention. FIG. 5D shows a different arrangement of the bonding wires connected between the current transmission pad IPAD, common voltage pad COMPAD, and extra pad EXTPAD. FIG. 5E shows the implementation in which two extra pads EXTPAD1˜EXTPAD2 are added. FIG. 5F shows a bonding wire arrangement different from the arrangement of FIG. 5E. In these implementations, the equivalent resistance R formed in FIG. 5D is R=RC+RA×RB/(RA+RB), the equivalent resistance R formed in FIG. 5E is R=RA+RB+RC, and the equivalent resistance R formed in FIG. 5D is R=RA+RB×RD/(RB+RD)+RC.

Further, similar to those described in the first embodiment, the second embodiment may also employ multiple pads and multiple bonding wires. FIG. 5G illustrates a further implementation of the current detection apparatus according to the second embodiment of the present invention. Referring to FIG. 5, the current detection apparatus includes multiple extra pads EXTPAD 1˜EXTPAD 3, and multiple bonding wires may be connected among the extra pads, EXTPAD 1˜EXTPAD 3, common voltage pad COMPAD and current transmission pad IPAD. Therefore, the number of the bonding wires is not limited to those described in foregoing implementations.

It should be noted, however, no matter how the current detection apparatus is implemented, it is within the scope of the present invention as long as the equivalent resistance is formed by bonding wires connected between the current transmission pad IPAD and common voltage pad COMPAD.

As described in the first embodiment, in each of the various implementations of the current detection apparatus 500 of the second embodiment, the package carrier 530 can likewise be encapsulated by sealing resin to protect the bonding wires and prevent the equivalent resistance from varying with outer environment.

### Third Embodiment

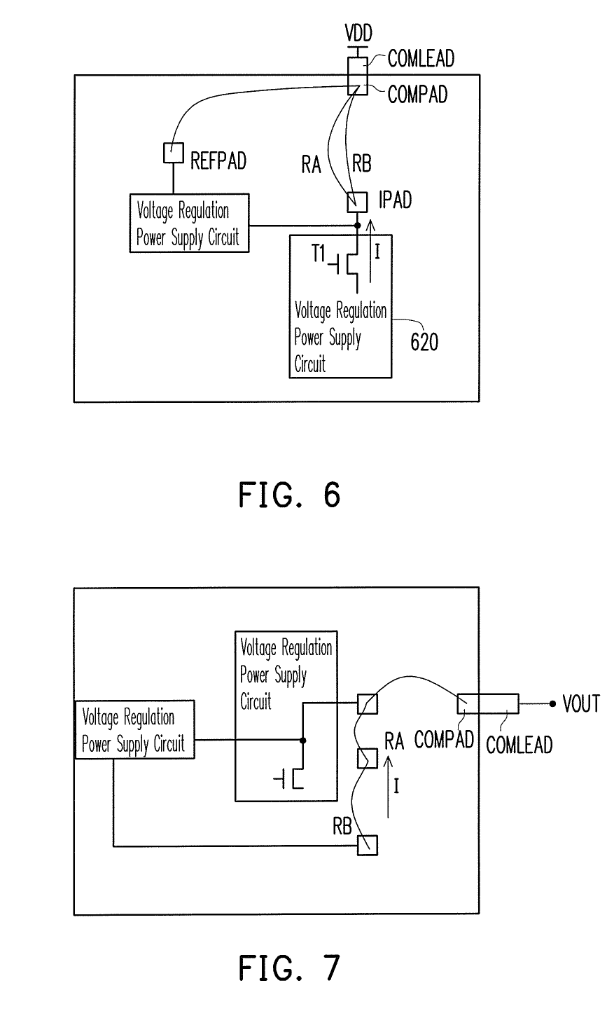

FIG. 6 illustrates a current detection apparatus according to a third embodiment of the present invention. Referring to FIG. 6, in the third embodiment, the common voltage lead COMLEAD is electrically connected to a system voltage VDD. This implementation is commonly employed when the transistor 11 is a P-type metal oxide semiconductor (PMOS), in which situation the common voltage lead COMLEAD must be electrically connected to the system voltage VDD due to characteristics of the PMOS.

In addition, in the third embodiment of the present invention, the equivalent resistance may be formed by bonding wires connected between the reference pad REFPAD and the current transmission pad IPAD as in the first embodiment, and may also be formed by bonding wires connected between the common voltage pad COMPAD and current transmission pad IPAD as in the second embodiment. The bonding wires can be arranged in the same manner as described in the first and second embodiments, which is not repeated herein.

### Fourth Embodiment

FIG. 7 illustrates a current detection apparatus according to a fourth embodiment of the present invention. Referring to FIG. 7, in the fourth embodiment, the common voltage lead COMLEAD is electrically connected to an output voltage VOUT. In the fourth embodiment of the present invention, the equivalent resistance may be formed by bonding wires connected between the reference pad REFPAD and the current transmission pad IPAD as in the first embodiment, and may also be formed by bonding wires connected between the common voltage pad COMPAD and current transmission pad IPAD as in the second embodiment. The bonding wires can be arranged in the same manner as described in the first and second embodiments, which is not repeated herein.

### Fifth Embodiment

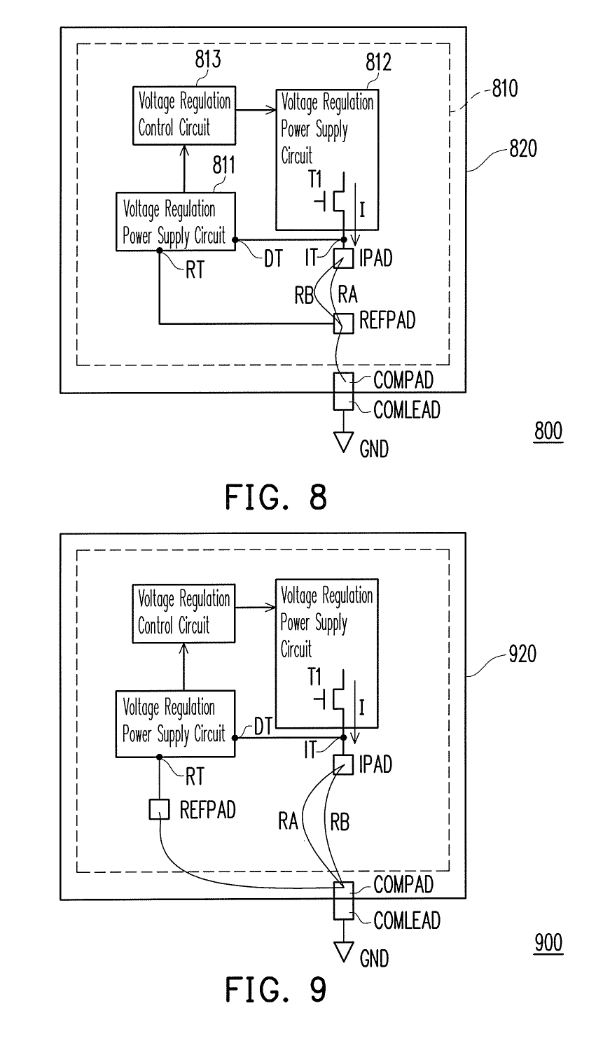

FIG. 8 illustrates a power converter according to one embodiment of the present invention. Referring to FIG. 8, the power converter 800 includes a power converter chip 810 and a package carrier 820. The package carrier 820 is used to carry the power converter chip 810 and includes a common voltage lead COMLEAD electrically connected to a common voltage pad COMPAD.

The power converter chip 810 includes a current detection circuit 811, a voltage regulation power supply circuit 812, and a voltage regulation control circuit 813. The current detection circuit 811 includes a reference terminal RT and a detection terminal DT. The reference terminal RT is electrically connected to a reference pad REFPAD, and the reference pad REFPAD is electrically connected to the common voltage pad COMPAD. The power regulation power supply circuit 812 includes a power transistor T1. The power transistor T1 generates a current I in response to a signal received at the gate of the power transistor T1. The first source/drain or the second source/drain of the power transistor T1 is electrically connected to a current transmission terminal IT. In addition, the current transmission terminal IT is electrically connected to a current transmission pad IPAD.

In addition, the voltage regulation control circuit 813 is coupled to the current detection circuit 811 and the voltage regulation power supply circuit 812. The voltage regulation control circuit 813 regulates the value of the current I of the power transistor T1 of the voltage regulation power supply circuit 812 according to the current detected by the current detection circuit.

Regarding current detection, the power converter apparatus 800 of the fifth embodiment is constructed and operated in the same way as described in relation to the current detection apparatus 400 of the first embodiment. That is, in the power converter apparatus 800, bonding wires are connected between the current transmission pad IPAD and reference pad REFPAD to form a equivalent resistance R, and the current I is detected by detecting a voltage between the current transmission pad IPAD and reference pad REFPAD (i.e., the voltage between the reference terminal RT and the detection terminal DT). Therefore, the current detection part can be understood by referring to the description of the first embodiment and is not repeated herein.

As in the first embodiment, the package carrier 820 of the fifth embodiment can likewise be encapsulated by sealing resin to protect the bonding wires and prevent the equivalent resistance from varying with outer environment.

In addition, while the common voltage lead COMLEAD is electrically connected to the ground voltage GND as described in the fifth embodiment, the common voltage lead COMLEAD can also be connected to the system voltage or output voltage as described in the third or fourth embodiment.

### Sixth Embodiment

FIG. 9 illustrates a power converter according to another embodiment of the present invention. Referring to FIG. 9, the power converter 900 of the sixth embodiment is different from the power converter 800 of the fifth embodiment in that the bonding wires forming the equivalent resistance are connected to different pads. The bonding wires forming the equivalent resistance of the sixth embodiment are connected between the current transmission pad IPAD and the common voltage pad COMPAD as in the second embodiment.

Regarding the forming of the equivalent resistance by the bonding wires and operation of the current detection, the power converter 900 of the sixth embodiment is constructed and operated in the same manner as described in relation to the current detection apparatus 500 of the second embodiment and, therefore, is not repeated herein.

The package carrier 930 of the sixth embodiment can likewise be encapsulated by sealing resin to protect the bonding wires and prevent the equivalent resistance from varying with outer environment. In addition, the common voltage lead COMLEAD of the sixth embodiment can likewise be connected to the ground voltage, the system voltage or the output voltage.

It is to be noted that, if the power converter as described in the fifth and sixth embodiments is implemented in an on-chip manner, an extra lead for external connection of a resistor for current detection is not required. Instead, the resistance for current detection can be formed by bonding wires connected among the current transmission pad IPAD, reference pad REFPAD and common voltage pad COMPAD in the chip as described in the foregoing embodiments. As such, the present invention can effective save the area of the chip.

In summary, the present invention employs one or multiple bonding wires connected in different manners to form an equivalent resistance between a reference terminal and a detection terminal to enable the current detection circuit to detect the current. No extra area of the circuit is occupied which decreases the cost. In addition, the resistance of the bonding wires can be measured prior to the wire-bonding process, thereby effectively increasing the precision of the current detection.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A current detection apparatus comprising:
a current detection circuit having a reference terminal and a detection terminal, the reference terminal electrically connected to a reference pad, the reference pad electrically connected to a common voltage pad;
a voltage regulation power supply circuit configured to generate an output voltage and comprising a current transmission terminal for transmitting a current, the current transmission terminal electrically connected to a current transmission pad and the detection terminal; and
a package carrier for carrying the current detection circuit, the voltage regulation power supply circuit, the reference pad, and the current transmission pad, the package carrier comprising at least one common voltage lead for electrically connection with the common voltage pad;
wherein the current transmission pad is coupled to the reference pad through at least one bonding wire such that an equivalent resistance is formed on the coupling path between the current transmission pad and the reference pad.

2. The current detection apparatus according to claim 1, further comprising at least one extra pad, wherein the at least one bonding wire is connected among the extra pad, the current transmission pad and the reference pad.

3. The current detection apparatus according to claim 1, wherein the voltage between the reference pad and the detection terminal that is detected by the current detection circuit is equal to the product of the current and the equivalent resistance.

4. The current detection apparatus according to claim 1, wherein the common voltage pad is connected to and receives the output voltage, a system voltage or a ground voltage.

5. The current detection apparatus according to claim 1, wherein the voltage regulation power supply circuit comprises a transistor having a gate, a first source/drain, and a second source/drain, the transistor generates a current in response to a signal received at the gate, the first source/drain or the second source/drain is electrically connected to the current transmission terminal.

6. The current detection apparatus according to claim 1, further comprising sealing resin for encapsulating the package carrier.

7. A current detection apparatus comprising:
a current detection circuit having a reference terminal and a detection terminal, the reference terminal electrically connected to a reference pad, the reference pad electrically connected to a common voltage pad;
a voltage regulation power supply circuit configured to generate an output voltage and comprising a current transmission terminal for transmitting a current, the current transmission terminal electrically connected to a current transmission pad; and
a package carrier for carrying the current detection circuit, the voltage regulation power supply circuit, the reference pad, and the current transmission pad, the package carrier comprising at least one common voltage lead for electrically connection with the common voltage pad;
wherein the current transmission pad is coupled to the reference pad through at least one bonding wire such that an equivalent resistance is formed on the coupling path between the current transmission pad and the common voltage pad.

8. The current detection apparatus according to claim 7, further comprising at least one extra pad, wherein the at least one bonding wire is connected among the extra pad, the current transmission pad and the common voltage pad.

9. The current detection apparatus according to claim 7, wherein the voltage between the reference pad and the detection terminal that is detected by the current detection circuit is equal to the product of the current and the equivalent resistance.

10. The current detection apparatus according to claim 7, wherein the common voltage pad is connected to and receives the output voltage, a system voltage or a ground voltage.

11. The current detection apparatus according to claim 7, wherein the voltage regulation power supply circuit comprises a transistor having a gate, a first source/drain, and a second source/drain, the transistor generates a current in response to a signal received at the gate, the first source/drain or the second source/drain is electrically connected to the current transmission terminal.

12. The current detection apparatus according to claim 7, further comprising sealing resin for encapsulating the package carrier.

13. A power converter comprising:
a power converter chip configured to generate an output voltage, the power converter chip comprising:
a current detection circuit having a reference terminal and a detection terminal, the reference terminal electrically connected to a reference pad, the reference pad electrically connected to a common voltage pad; and
a voltage regulation power supply circuit configured to generate the output voltage and comprising a current transmission terminal for transmitting a current, the current transmission terminal electrically connected to a current transmission pad and the detection terminal; and
a package carrier for carrying the power converter chip, the package carrier comprising at least one common voltage lead for electrically connection with the common voltage pad;
wherein the current transmission pad is coupled to the reference pad through at least one bonding wire such that an equivalent resistance is formed on the coupling path between the current transmission pad and the reference pad.

14. The power converter according to claim 13, further comprising at least one extra pad, wherein the at least one bonding wire is connected among the extra pad, the current transmission pad and the reference pad.

15. The power converter according to claim 13, wherein the voltage between the reference pad and the detection terminal that is detected by the current detection circuit is equal to the product of the current and the equivalent resistance.

16. The power converter according to claim 13, wherein the common voltage pad is connected to and receives the output voltage, a system voltage or a ground voltage.

17. The power converter according to claim 13, wherein the voltage regulation power supply circuit comprises a transistor having a gate, a first source/drain, and a second source/drain, the transistor generates a current in response to a signal received at the gate, the first source/drain or the second source/drain is electrically connected to the current transmission terminal.

18. The power converter according to claim 13, further comprising sealing resin for encapsulating the package carrier.

19. The power converter according to claim 13, wherein the power converter chip further comprises a voltage regulation control circuit coupled to the current detection circuit and the voltage regulation power supply circuit, and the voltage regulation control circuit is configured to regulate the value of the current generated by the voltage regulation power supply circuit according to the current detected by the current detection circuit.

20. A power converter comprising:
a power converter chip configured to generate an output voltage, the power converter chip comprising:
a current detection circuit having a reference terminal and a detection terminal, the reference terminal electrically connected to a reference pad, the reference pad electrically connected to a common voltage pad; and
a voltage regulation power supply circuit configured to generate the output voltage and comprising a current transmission terminal for transmitting a current, the current transmission terminal electrically connected to a current transmission pad; and
a package carrier for carrying the power converter chip, the package carrier comprising at least one common voltage lead for electrically connection with the common voltage pad;
wherein the current transmission pad is coupled to the reference pad through at least one bonding wire such that an equivalent resistance is formed on the coupling path between the current transmission pad and the common voltage pad.

21. The power converter according to claim 20, further comprising at least one extra pad, wherein the at least one bonding wire is connected among the extra pad, the current transmission pad and the common voltage pad.

22. The power converter according to claim 20, wherein the voltage between the reference pad and the detection terminal that is detected by the current detection circuit is equal to the product of the current and the equivalent resistance.

23. The power converter according to claim 20, wherein the common voltage pad is connected to and receives the output voltage, a system voltage or a ground voltage.

24. The power converter according to claim 20, wherein the voltage regulation power supply circuit comprises a transistor having a gate, a first source/drain, and a second source/drain, the transistor generates a current in response to a signal received at the gate, the first source/drain or the second source/drain is electrically connected to the current transmission terminal.

25. The power converter according to claim 20, further comprising sealing resin for encapsulating the package carrier.

26. The power converter according to claim 20, wherein the power converter chip further comprises a voltage regulation control circuit coupled to the current detection circuit and the voltage regulation power supply circuit, and the voltage regulation control circuit is configured to regulate the value of the current generated by the voltage regulation power supply circuit according to the current detected by the current detection circuit.
